(19) United States
(12) Patent Application Publication
(10) Pub. No.: US 2026/0220483 A1
(43) Pub. Date: Jul. 30, 2026

(54) FEDERATED OPEN SET LEARNING AND INFERENCE FOR DOCUMENT CLASSIFICATION

(71) Applicant: Dell Products L.P., Round Rock, TX (US)

(72) Inventors: Vinicius Michel Gottin, Rio de Janeiro (BR); Paulo Abelha Ferreira, Rio de Janeiro (BR); Pablo Nascimento da Silva, Niterói (BR)

(21) Appl. No.: 19/038,063

(22) Filed: Jan. 27, 2025

(51) Int. Cl. G06N 3/098; G06F 16/906; G06F 16/93; G06N 3/0475

(52) U.S. Cl. CPC G06N 3/098; G06F 16/906; G06F 16/93; G06N 3/0475

(57) ABSTRACT

Various embodiments relate to a method involving edge nodes within a federation receiving first machine learning (ML) models from a central node, which pertain to both locally known and unknown document classes. The edge nodes generate generative synthetic document samples for locally known document classes using these models and locally known document samples, and then provide these samples to the central node. Subsequently, the edge nodes receive second ML models from the central node, trained using the generative synthetic document samples, covering all document classes known to the federation. Additionally, the edge nodes receive representative generative synthetic document samples for locally unknown document classes. The edge nodes then perform document classification on received documents using the second ML models, along with the representative generative synthetic document samples and locally known document samples.

### TECHNOLOGICAL FIELD OF THE DISCLOSURE

Embodiments of the present invention generally relate to federated learning processes. More particularly, at least some embodiments of the invention relate to systems, hardware, software, computer-readable media, and methods for training and using a federated learning process in document classification.

### BACKGROUND

Federated Learning (FL) consists of a distributed framework for Machine Learning in which a global model is trained jointly by several nodes without ever sharing their local data. Because the edge nodes never share their respective local data, FL is able to implement strong privacy guarantees. However, the strong privacy guarantees can make it difficult for a FL system to perform document classification, which is determining whether a document (e.g., a pdf document) belongs to one of multiple known classes—either a purchase order, receipt, medical imaging exams, etc.

For example, to maintain the strong privacy guarantees, in applications dealing with legal (or financial, healthcare, etc.) document processing, it is not possible for a document to be sent to a central processing node for classification because each local node of the FL system does not share data between each other. In other words, it is undesirable for a local node to reveal its data to another node, for security and compliance reasons.

This leads to the result that if a certain node A is prepared to classify financial documents, that node may not be prepared to handle a legal document which may eventually be ingested in the document processing pipeline. Another node B, however, may routinely deal with such legal documents, and therefore may be capable of classifying that document correctly. However, since nodes A and B cannot share data, node A is unable to leverage the experience of node B if it must classify a legal document.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of Federated Learning.

FIG. 2 discloses aspects of document classification.

FIGS. 3A-3B disclose aspects of an edge environment.

FIGS. 4A-4E disclose aspects of training C-GANs in a federated edge environment;

FIGS. 5A-5B disclose aspects of collecting generative synthetic document samples in a federated edge environment.

FIGS. 6A-6C disclose aspects of training meta-classifiers in a federated edge environment.

FIGS. 7A-7D disclose aspects of document classification in a federated edge environment.

FIG. 8 discloses aspects of a method according to one embodiment.

FIG. 9 discloses a computing entity configured and operable to perform any of the disclosed methods, processes, and operations.

### DETAILED DESCRIPTION OF SOME EXAMPLE EMBODIMENTS

Embodiments of the present invention generally relate to federated learning processes. More particularly, at least some embodiments of the invention relate to systems, hardware, software, computer-readable media, and methods for training and using a federated learning process in document classification.

In general, example embodiments of the invention are directed towards document classification in a federated edge environment. Various embodiments relate to a method involving edge nodes within a federation receiving first machine learning (ML) models from a central node, which pertain to both locally known and unknown document classes. The edge nodes generate generative synthetic document samples for locally known document classes using these models and locally known document samples, and then provide these samples to the central node. Subsequently, the edge nodes receive second ML models from the central node, trained using the generative synthetic document samples, covering all document classes known to the federation. Additionally, the edge nodes receive representative generative synthetic document samples for locally unknown document classes. The edge nodes then perform document classification on received documents using the second ML models, along with the representative generative synthetic document samples and locally known document samples.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that a way is provided for edge nodes in a Federated Learning (FL) environment to leverage the knowledge of other edge nodes when performing document classification while still being able to maintain the privacy guarantees of FL. Thus, the edge nodes share their knowledge about document classes while keeping local document samples secret. This allows the edge nodes in the FL environment to be trained to classify unknown documents they receive and ensures the unknown documents are sent to the proposer processing pipeline, thus saving on system processing and computing resources.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

Federated Learning (FL) consists of a distributed framework for Machine Learning in which a global model is trained jointly by several edge nodes without ever sharing their local data. Because the edge nodes never share their respective local data, FL is able to implement strong privacy guarantees. However, the strong privacy guarantees can make it difficult for a FL system to perform document classification, which is determining whether a document (e.g., a pdf document) belongs to one of multiple known classes—either a purchase order, receipt, medical imaging exams, etc.

The embodiments disclosed herein provide mechanisms for performing document classification at edge nodes of the FL system, while still maintaining the strong privacy guarantees that make FL desirable. Furthermore, the embodiments disclosed herein provide mechanisms for classifying a document that may not belong to any known classes at an edge node, when the class may be known at another edge node. Accordingly, the embodiments disclosed herein allow the following to occur:
1. Enable each node to classify its own locally available documents,
2. leveraging cross-node experiences to extend the classification capabilities, but keeping full data privacy, such that
3. the edge node is able to flag documents that pertain to an unknown class at that edge node, but known elsewhere, and
4. being able to flag documents that pertain to an unknown class across all nodes (not known anywhere).

Thus, the embodiments disclosed herein provide mechanisms for performing document classification at edge nodes of the FL system when nodes share some document classes, but are not necessarily exposed to the same classes. To this end the embodiments disclosed herein combine both Federated learning and Open Set Learning in a novel way for document classification, which allows each edge node to leverage knowledge from all nodes to classify incoming documents as belonging to node-known classes, federation-known classes or federation-unknown. This classification can then be used by other systems to retrieve, store or analyze documents. Furthermore, the classification into federation-unknown might be used to flag certain documents as possibly of a new unknown class (open set).

Accordingly, the embodiments disclosed herein define a framework that keeps original data at the edge nodes exclusively, and still allows the edge nodes to jointly learn distributed synthetic models of the data. In the embodiments, Generative Adversarial Networks (GANs) and FL are utilized to enable each edge node to learn a surrogate distribution to that of the whole data present at all nodes without having to share the data, thus keeping it private as required by FL. This distribution allows for the training of meta-classifiers that can be distributed to all edge nodes and used for document classification inference as will be explained in more detail to follow.

### B. Context

In general, some embodiments are directed to resolving one or more challenges posed by document classification in Federated Learning (FL). Following is contextual information for some example embodiments.

### B.1 Federated Learning

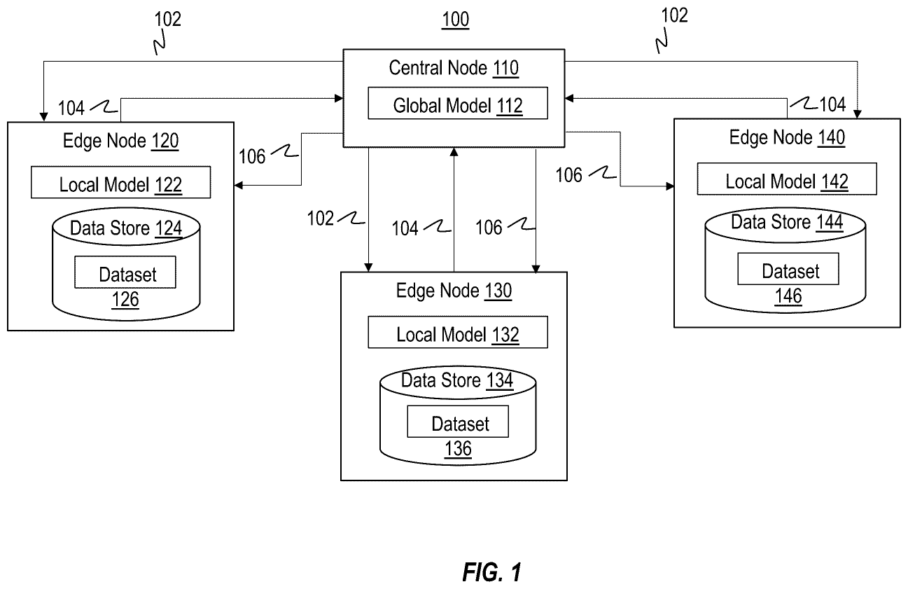

As shown in FIG. 1, in a FL setting 100, a server 110 (i.e., a central node) provides an initial global model 112 to a client node 120, a client node 130, and a client node 140 as shown at 102. The client node 120 includes a local model 122 and a local data store 124 that stores a local dataset 126. The client node 130 includes a local model 132 and a local data store 134 that stores a local dataset 136. The client node 140 includes a local model 142 and a local data store 144 that stores a local dataset 146. The global model 112 and the local models 122, 132, and 144 (and any other model disclosed herein) may be any reasonable ML model such as, but not limited to, deep neural networks, convolutional neural networks, multilayer neural networks, recursive neural networks, logistic regressions, isolation forests, k-nearest neighbors, support vector machines (SVM), or any other reasonable machine-learning model. It will be understood that the local models are local versions of the global model that is provided to the client nodes by the server during an initial cycle.

The client node 120 performs local training on the local model 122 using the local dataset 126. Likewise, the client node 130 performs local training on the local model 132 using the local dataset 136. In similar manner, the client node 140 performs local training on the local model 142 using the local dataset 146.

As a result of the local training, the local models 122, 132, and 142 are updated to fit the local datasets 126, 136, and 146 respectively to the global model 112. As shown at 104, the updated local models 122, 132, and 142 are sent as model gradients by the client nodes to the server 110, which aggregates the updates of all client nodes to obtain an updated global model 112. This new updated global model 112 is then sent back to the client nodes 120, 130, and 140 as shown at 106 and become the local models 122, 132, and 142. This cycle is repeated iteratively for a user determined amount of update rounds. It will be noted that after each cycle, each of the client nodes have a local model (i.e., local models 122, 132, and 142) that not only fits each client nodes local datasets (i.e., local datasets 126, 136, and 146), but that also fits the local datasets of the other client nodes, resulting in a local model with a good generalization. This process allows FL to provide strong privacy-preserving guarantees since datasets are never communicated between nodes, which, in turn, reduces network communication by a significant fraction. Additional gradient compression techniques can be used to further reduce network costs.

In summary:
1. The edge nodes download the current model from the central node. If it is the first cycle, the shared model is randomly initialized.
2. Then, each edge node trains the model using its local data during a user-defined number of epochs.
3. The model updates are sent from the edge nodes to the central nodes. In some embodiments, these updates are vectors containing the model gradients.
4. The central node aggregates these vectors and update the shared model, in some embodiments the classic way of aggregating vectors is through a simple averaging process (Federated Average).
5. If the predefined number of cycles is reached, the training is finished, otherwise the process returns to step 1.

### B.2 Open Set and Open World Learning

The open set formulation of Machine Learning classification tasks assumes that not all classes that the model will encounter when deployed (i.e. in testing) are present in the training (i.e. no samples for those classes exist). Open Set Machine Learning techniques are concerned with defining boundaries over known classes, providing mathematical definitions and modified classifiers to deal with these boundaries. Open Set research (also called “Open World”) additionally concerns assimilating the unknown classes into the model's repertoire.

Open set models are usually extensions of the Support Vector Machine canonical formulation. One example embodiment uses a modified auto-classifier. Open set models are thus broadly general and may be applied to a wide range of domains. For example, some of the domains in which open set object detection are required are “unconstrained optical character recognition (OCR) and photo or video tagging without constraints on the input” and autonomous driving. Open set formulations may apply to any classification task, however, if it possible and relevant that certain classes are not known at training time.

One embodiment uses a L2AC framework for Open World Learning (OWL), consisting of two main parts: a ranker and a meta-classifier. The ranker determines, for a new sample x and one known class Cᵢ, the top-k closest examples

$${s}_{i}^{0} , {s}_{i}^{1} , … , {s}_{i}^{k - 1}$$

of samples belonging to that class that are ‘most similar’ to x. There is one meta-classifier M; corresponding to each known class Cᵢ. The meta-classifier takes both the test sample x and the top-k nearest examples and produces a probability score for the corresponding class. Additional information related to the L2AC framework for Open World Learning is disclosed in “H. Xu, B. Liu and P. Yu, ‘Open-world Learning and Application to Product Classification,’ eprint arXiv:1809.06004, 2018” which is incorporated herein in its entirety by this reference. The embodiments disclosed herein extend and adapt the L2AC framework in a federated fashion.

### B.3 Conditioned GAN

A generative adversarial network (GAN) is an approach for training a generative model in tandem with a discriminative model. The joint training ensures that the generative model learns the data distribution, with the discriminative model learning to distinguish generated samples (from the generative model) from the original samples (from the training set).

A conditional GAN extends the generative and discriminative models to also consider extra information, typically feeding that information as an extra input layer. Conditioning the GAN with one of the classes allows for generating samples of the desired class. In some embodiments, conditional GANS are able to generate samples of a desired class that are similar to a provided sample.

### B.4 Document Classification

The document classification task consists of determining the appropriate “class” of a document for a downstream application. As used herein, the “class” of a document may refer to any characteristics that influence the processing pipeline and/or are relevant for the downstream application. For example, it may consist of the document's domain (legal, healthcare, financial), its type (text, table, slides, etc.), its content template (relation between positional space and content), its format (coloring, fonts, formatting), etc.

As used herein, an application may be whatever process, software or not, requiring the information extracted from the documents. This may comprise any domain-specific business logic and algorithms, embedding for Resource-Augmented Generation (RAG), compression for long-term storage, etc.

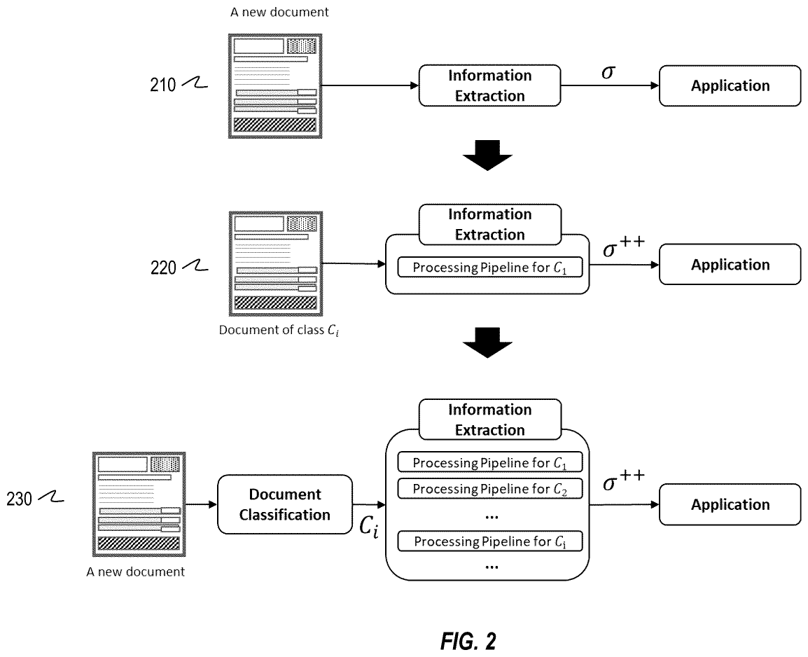

FIG. 2 illustrates a document classification task. For example, as shown at 210, a typical information extraction pipeline is illustrated. The pipeline extracts information a from a new document and provides it to the downstream applications.

However, as shown at 220, if the class of the document is known, it is possible to leverage a specific document processing pipeline for that document. Such class-specific processes often yield a higher “quality” of information represented as σ++ for the downstream applications.

Hence, the document classification task as shown at 230. In the document classification task, it is possible to determine the class of a new, never before seen document, such that it is possible to route the new, never before seen document to the appropriate processing pipeline.

### B.4 Document Classification at an Edge Node

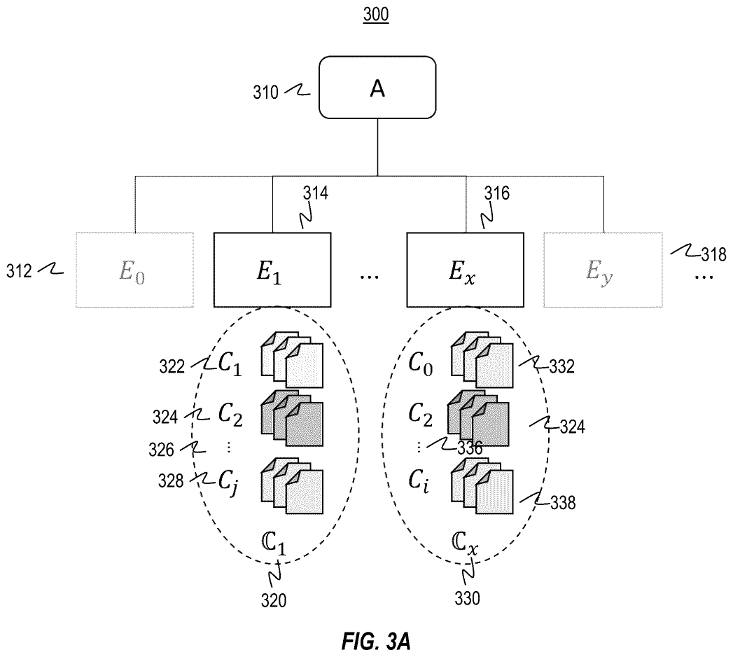

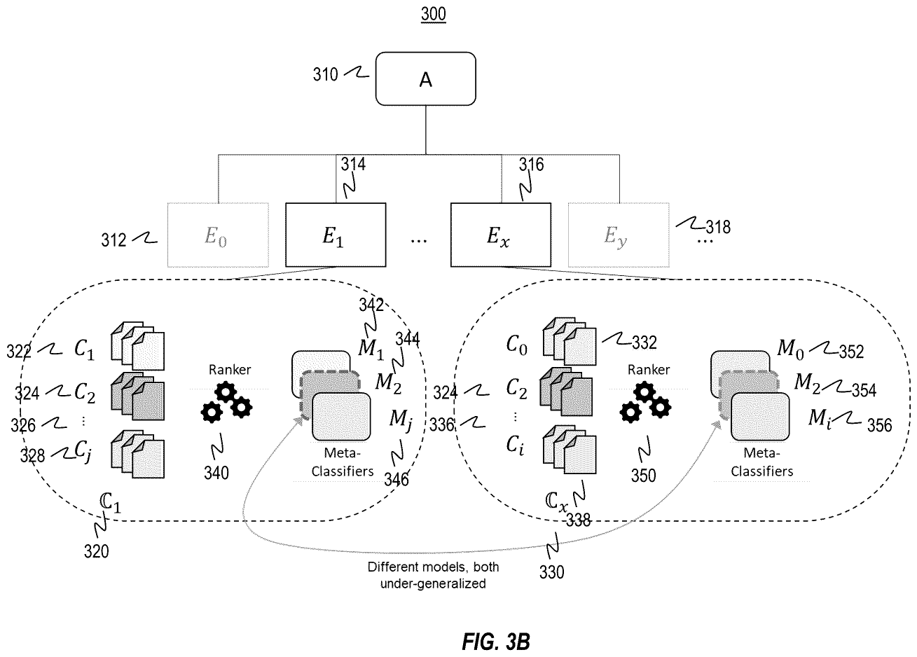

FIG. 3A illustrates an embodiment of an edge environment 300 with a central node A 310 and edge nodes E₀ 312, E₁ 314, . . . , Eₓ 316, E_{y} 318, . . . ; and any number of additional nodes as illustrated by the ellipses. In the embodiment, each edge node performs document classification independently. As a result, each edge nodes has a set of known document classes and associated samples of real documents that are included in the known document classes as shown in the figures. For ease of illustration, only the set of known document classes [symbol] ₁ 320 for node E₁ 314 and the set of known document classes [symbol] ₓ 330 for Eₓ 316 are shown.

As illustrated, the set of known document classes [symbol] ₁ 320 for node E₁ 314 includes a class C₁ 322, a class C₂ 324, any number of additional classes 326 as illustrated by the ellipses up to a class Cⱼ 328. The set of known document classes [symbol] ₓ 330 for node Eₓ 316 includes a class C₀ 332, the class C₂ 324, any number of additional classes 336 as illustrated by the ellipses up to a class Cᵢ 338. FIG. 3A shows that while each edge node has its own set of known classes of documents, some intersections are possible. For example, both sets of known document classes [symbol] ₁ 320 and [symbol] ₓ 330 include the class C₂ 324.

The scenario of the embodiment of FIG. 3A leads to the following observations:
1. It is possible to leverage data from the multiple nodes that know a same class for the training of a document classification model. That is, in the embodiment of FIG. 3A it is possible to use data from edge nodes E₁ 314 and Eₓ 316 to learn to recognize documents of class C₂ 324.
2. A document of a class that is known at one edge node may be unknown at another. If node E₁ 314 obtains a document of class C₀ 332, it will be unable to correctly classify it unless the document classification model leverages data from Eₓ 316 during training.
3. There may documents of completely unknown classes—not known at any edge nodes

From 1 and 2 above, a requirement is seen for leveraging data from all edge nodes for the training of a document classification model. However, the data privacy constraints of FL apply. Thus, there should be a strict policy of not allowing any documents from any edge nodes to be transferred to any other, or to the central node A 310. From 3 it is seen that a document classification model should be able to determine whether a document belongs to a completely new unseen class, which may be useful to capture—for example—erroneous documents.

In some embodiments, it is possible to train a local classifier at each node. Then, at inference time it would be possible to know if a sample pertained to a known or unknown class for that given node. This is shown in FIG. 3B, where the L2AC framework discussed previously is applied to the edge environment 300.

As shown in FIG. 3B, a ranker 340 is used with a meta-classifier M₁ 342 for class C₁ 322, a meta-classifier M₂ 344 for class C₂ 324, any number of additional meta-classifiers (not illustrated) for the additional classes 326 up to a meta-classifier Mⱼ 346 for class Cⱼ 328. In addition, a ranker 350 is used with a meta-classifier M₀ 352 for class C₀ 332, a meta-classifier M₂ 354 for class C₁ 324, any number of additional meta-classifiers (not illustrated) for the additional classes 336 up to a meta-classifier Mᵢ 356 for class Cᵢ 338.

The scenario of the embodiment of FIG. 3B leads to the following observations:
1. The meta-classifier M₂ 344 is generated using only documents at edge node E₁ 314, ignoring those documents of the same class in other nodes. Likewise, the meta-classifier M₂ 354 is generated using only documents at edge node Eₓ 316, ignoring those documents of the same class in other nodes. This leads to the result that the meta-classifier M₂ 344 and the meta-classifier M₂ 354 are entirely different models, even though both were generated using class C₂ 324. Being trained on smaller datasets, both the meta-classifier M₂ 344 and the meta-classifier M₂ 354 may be less accurate and general than an ideal meta-classifier trained with all available data, across all the edge nodes.
2. This approach allows E₁ 314 to identify a document as of “unknown class”, but disregards that the class may be known at other edge nodes. For example, a document of class C₀ 332 is just “unknown” to edge node E₁ 314. Put another way, even if edge node E₁ 314 were aware that edge node Eₓ 316 can deal with documents of class C₀ 332, edge node E₁ 314 has no way of identifying that a document of an unknown class belongs to the class C₀ 332.
3. Finally, edge node E₁ 314 cannot distinguish between a document of a class C₀ 332 (known elsewhere) from a document of a completely new class. This is important so that the edge node can recognize that a document is a completely new format, or is a document of a known class but erroneously composed.

### C. Detailed Discussion of Aspects of an Embodiment

In order to overcome the problems of the embodiment of FIG. 3B and the problems of other existing document classification systems, the embodiments disclosed herein provide a mechanism for training, in federated fashion, conditional generative adversarial networks (C-GANs) for each document class. The embodiments leverage samples from these C-GANs for enabling the training of meta-classifiers, in an approach that keeps the privacy guarantees of FL for the data at each edge node. This results in meta-classifiers that can be distributed to all edge nodes and used for document classification inference.

The embodiments disclosed herein include the following steps:

In offline fashion:
1. C-GANs are trained for each class and in federated fashion
2. A set of generative samples for each document class is obtained at the central node
3. The generative samples of each class are used to train a meta-classifier for that class, not subject to a ranker as in the L2AC approach
4. The meta-classifiers of all classes, and representative samples of classes unknown at a given edge node are distributed to each edge node

This enables, in online fashion:

Each edge node is capable of classifying each new document it receives into either one of its known classes, a federation-known class, or an unknown class.

Each of these steps will be explained in more detail to follow.

### C.1 Federated C-GAN Training

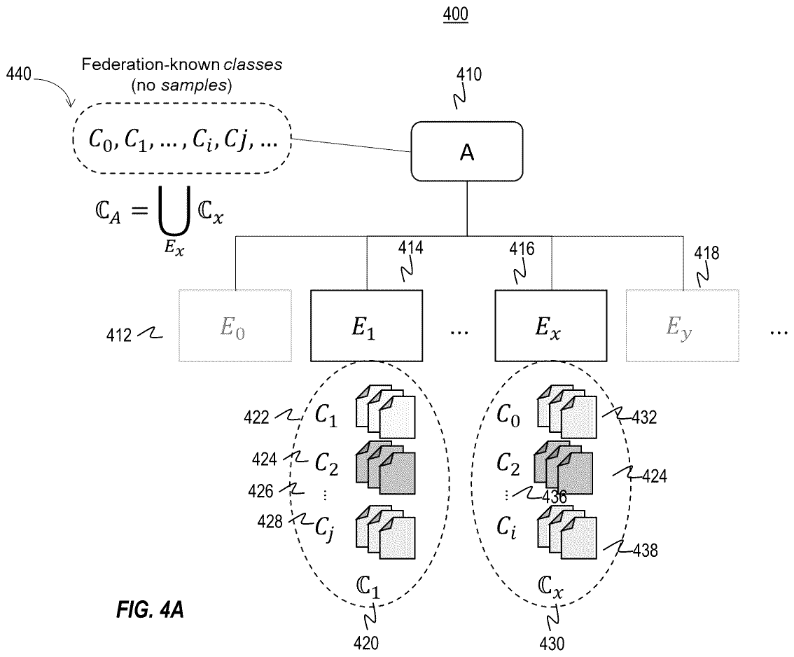

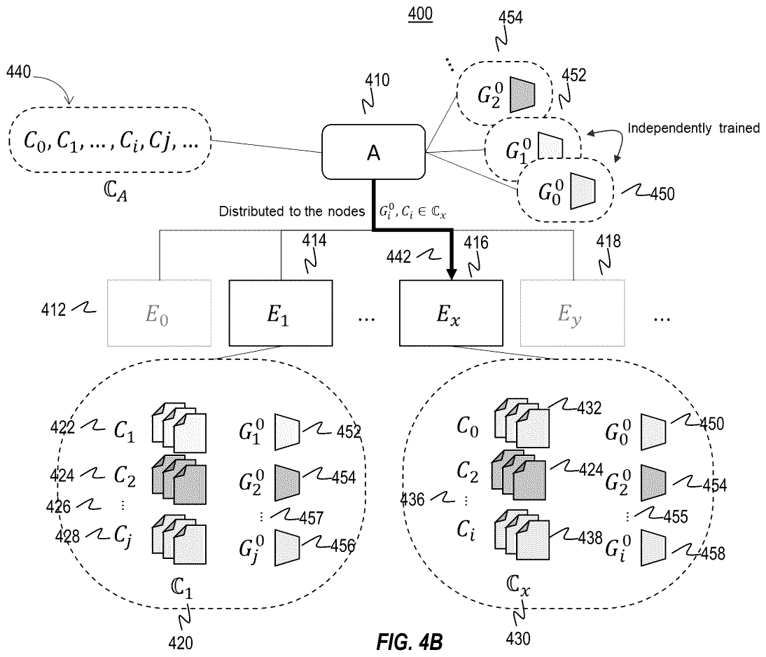

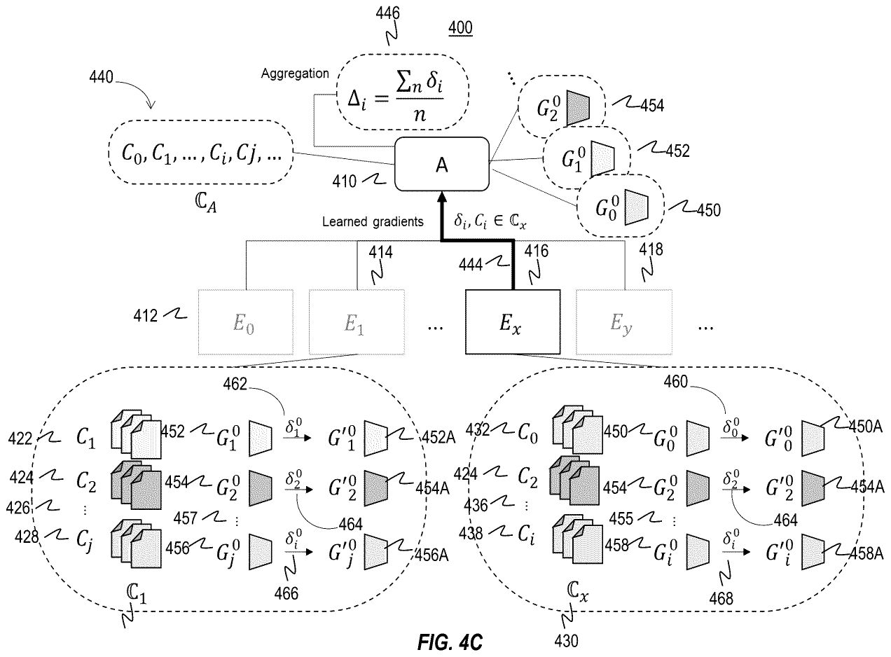

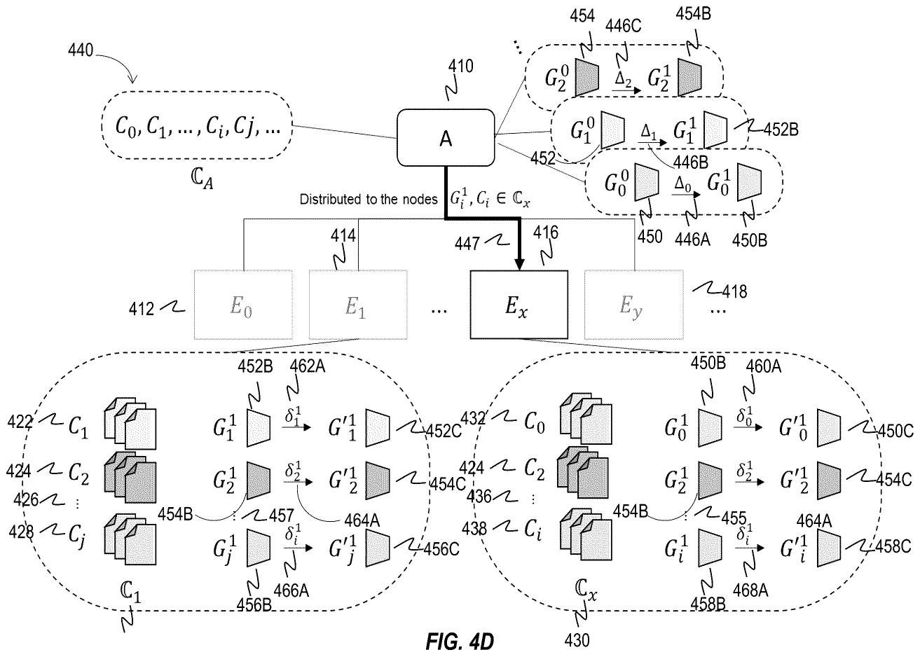

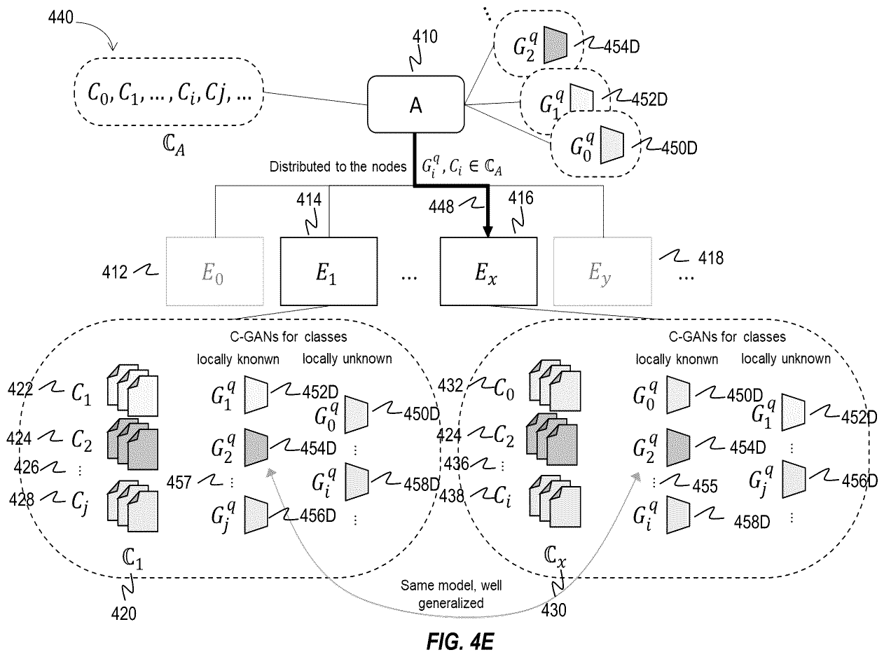

FIG. 4A illustrates an embodiment of an edge environment 400 with a central node A 410 and edge nodes E₀ 412, E₁ 414, . . . , Eₓ 416, E_{y} 418, . . . ; and any number of additional nodes as illustrated by the ellipses. In the embodiment, each edge node performs document classification independently. As a result, each edge nodes has a set of known document classes and associated samples of real documents that are included in the known document classes as shown in the figures. That is, a reference herein to a document class is also a reference to the illustrated samples of real documents shown in the figures. For ease of illustration, only the set of known document classes [symbol] ₁ 420 for node E₁ 414 and the set of known document classes [symbol] ₓ 430 for Eₓ 416 are shown.

As illustrated, the set of known document classes [symbol] ₁ 420 for node E₁ 414 includes a class C₁ 422, a class C₂ 424, any number of additional classes 426 as illustrated by the ellipses up to a class C₁ 428. The set of known document classes [symbol] ₓ 430 for node Eₓ 416 includes a class C₀ 432, the class C₂ 424, any number of additional classes 436 as illustrated by the ellipses up to a class Cᵢ 428. FIG. 4A shows that while each edge node has its own set of known classes of documents, some intersections are possible. For example, both sets of known document classes [symbol] ₁ 420 and [symbol] ₓ 430 include the class C₂ 424.

During an initialization step, each of the edge nodes E₀ 412, E₁ 414, Eₓ 416, and E_{y} 418 communicates each of its respective known document classes to the central node A 410, if those document classes are not already available at the central node. The central node A 410 then generates a federation set of known document classes [symbol] _{A} 440 that includes all of the known document classes that were communicated by the various edge nodes.

It will be appreciated that although the edge nodes communicate their respective known document classes to the central node A 410, there are no actual samples of any documents that are sent to the central node. Thus, even though it is possible that document classes known by each edge node could be leaked to the whole federation, this does not violate the privacy guarantees of FL as this in no way enables the discovery of real samples from any edge nodes.

As shown in FIG. 4B, once the central node A 410 has generated the federation set of known document classes [symbol] _{A} 440, the central node A 410 trains a C-GAN network Gᵢ for class Cᵢ, with random weights, and distributes those random weights to each edge node. In other words, the central node A 410 trains a C-GAN for each of the known document classes. For example, as shown in the figure, the central node A 410 trains a C-GAN

$${G}_{0}^{0}$$

450 for the class C₀ 432, a C-GAN

$${G}_{1}^{0}$$

452 for the class C₁ 422, and a C-GAN

$${G}_{2}^{0}$$

454 for the class C₂ 424. Although not illustrated, the central node A 410 also trains any number of additional C-GANs 457 as illustrated by the ellipses for the additional classes 426 up to a C-GAN

$${G}_{j}^{0}$$

456 for the class Cⱼ 428 and trains any number of additional C-GANs 455 as illustrated by the ellipses for the additional classes 436 up to a C-GAN

$${G}_{i}^{0}$$

458 for the class Cᵢ 438. It will be noted that each C-GAN at the central node A 410 is independently trained such that their training is not interdependent and indeed may be performed asynchronously.

As shown at 442, the central node A 410 then provides the initially trained C-GANs to each of the edge nodes having a class that matches the initially trained C-GANs. For example, as illustrated in FIG. 4B, the central node A 410 provides the initially trained C-GAN

$${G}_{1}^{0}$$

452 for the class C₁ 422, C-GAN

$${G}_{2}^{0}$$

454 for the class C₂ 424, and C-GAN

$${G}_{j}^{0}$$

456 for the class Cⱼ 428 to the edge node E₁ 414. Likewise, the central node A 410 provides the initially trained C-GAN

$${G}_{0}^{0}$$

450 for the class C₀ 432, C-GAN

$${G}_{2}^{0}$$

454 for the class C₂ 424, and C-GAN

$${G}_{i}^{0}$$

458 for the class Cᵢ 438 to the edge node E₀ 416.

As in traditional federated learning, each edge node then trains each of the received C-GANs independently, with locally available samples, for one training round, which is typically a set number of samples, or a time-bounded process, depending on the domain. This results in a new set of C-GANs

$${G}_{i}^{′ 0} .$$

In this notation, the ′ symbol reflects the locally trained new version of

$${G}_{i}^{0} .$$

For example, as illustrated in FIG. 4C, the edge node E₁ 414 trains the C-GAN

$${G}_{1}^{0}$$

452 using local samples to generate a C-GAN

$${G}_{1}^{′ 0}$$

452A, resulting in a learned gradient

$${δ}_{1}^{0}$$

### 462, the C-GAN

$${G}_{2}^{0}$$

454 using local samples to generate a C-GAN

$${G}_{2}^{′ 0}$$

454A, resulting in a learned gradient

$${δ}_{2}^{0}$$

### 464, and the C-GAN

$${G}_{j}^{0}$$

456 using local samples to generate a C-GAN

$${G}_{j}^{′ 0}$$

456A, resulting in a learned gradient

$${δ}_{j}^{0}$$

466. Likewise, the edge node Eₓ 416 trains the C-GAN

$${G}_{0}^{0}$$

450 using local samples to generate a C-GAN

$${G}_{0}^{′ 0}$$

450A, resulting in a learned gradient

$${δ}_{0}^{0}$$

### 460, the C-GAN

$${G}_{2}^{0}$$

454 using local samples to generate a C-GAN

$${G}_{2}^{′ 0}$$

454A, resulting in a learned gradient

$${δ}_{2}^{0}$$

### 464, and the C-GAN

$${G}_{i}^{0}$$

458 using local samples to generate a C-GAN

$${G}_{i}^{′ 0}$$

458A, resulting in a learned gradient

$${δ}_{i}^{0}$$

468. As shown at 444, the learned gradients δᵢ in the training of each

$${G}_{i}^{′ 0}$$

from

$${G}_{i}^{0}$$

are then communicated back to the central node for aggregation 446, which is some embodiments comprises averaging the n learned gradients.

As shown in FIG. 4D, the central node A 410 applies the aggregation 446 to each C-GAN

$${G}_{i}^{0}$$

and generates a next version of each C-GAN

$${G}_{i}^{1} ,$$

where the superscript index for each of the elements disclosed herein indicates the version of the model in the federated rounds. For example, as illustrated the central node A 410 applies an aggregation 446A to the C-GAN

$${G}_{0}^{0}$$

450 to generate a C-GAN

$${G}_{0}^{1}$$

450B, an aggregation 446B to the C-GAN

$${G}_{1}^{0}$$

452 to generate a C-GAN

$${G}_{1}^{1}$$

452B, and an aggregation 446C to the C-GAN

$${G}_{2}^{0}$$

454 to generate a C-GAN

$${G}_{2}^{1}$$

454B. Although not illustrated, the central node A 410 applies an aggregation to the C-GAN

$${G}_{i}^{1}$$

456 to generate a C-GAN

$${G}_{j}^{1}$$

456B and an aggregation to the C-GAN

$${G}_{i}^{0}$$

458 to generate a C-GAN

$${G}_{i}^{1}$$

### 458B.

As shown at 447, the central node sends the new versions of each C-GAN to each of the edge nodes for a new ‘round’ of the federated learning. For example, as illustrated in FIG. 4D, the edge node E₁ 414 trains the C-GAN

$${G}_{1}^{1}$$

452B using local samples to generate a C-GAN

$${G}_{1}^{′ 1}$$

452C, resulting in a learned gradient

$${δ}_{1}^{1}$$

### 462A, the C-GAN

$${G}_{2}^{1}$$

454B using local samples to generate a C-GAN

$${G}_{2}^{′ 1}$$

454C, resulting in a learned gradient

$${δ}_{2}^{1}$$

### 464A, and the C-GAN

$${G}_{j}^{1}$$

456B using local samples to generate a C-GAN

$${G}_{j}^{′ 1}$$

456C, resulting in a learned gradient

$${δ}_{j}^{1}$$

466A. Likewise, the edge node Eₓ 416 trains the C-GAN

$${G}_{0}^{1}$$

450B using local samples to generate a C-GAN

$${G}_{0}^{′ 1}$$

450C, resulting in a learned gradient

$${δ}_{0}^{1}$$

### 460A, the C-GAN

$${G}_{2}^{1}$$

454B using local samples to generate a C-GAN

$${G}_{2}^{′1}$$

454C, resulting in a learned gradient

$${δ}_{2}^{1}$$

### 464A, and the C-GAN

$${G}_{i}^{1}$$

458B using local samples to generate a C-GAN

$${G}_{i}^{′1}$$

458C, resulting in a learned gradient

$${δ}_{i}^{1}$$

468A. Although not illustrated, the learned gradients δᵢ in the training of each

$${G}_{i}^{′1}$$

from

$${G}_{i}^{1}$$

are then communicated back to the central node for aggregation 446 in the manner previously described.

FIG. 4E illustrates the edge environment 400 after q federated learning rounds. As illustrated, the central node has trained a C-GAN

$${G}_{0}^{q}$$

450D for the class C₀ 432, a C-GAN

$${G}_{1}^{q}$$

452D for the class C₁ 422, and a C-GAN

$${G}_{2}^{q}$$

454D for the class C₂ 424. Although not illustrated, the central node A 410 also trains any number of additional C-GANs 457 as illustrated by the ellipses for the additional classes 426 up to a C-GAN

$${G}_{j}^{q}$$

456D for the class Cⱼ 428 and trains any number of additional C-GANs 455 as illustrated by the ellipses for the additional classes 436 up to a C-GAN

$${G}_{i}^{q}$$

458D for the class Cᵢ 438.

The central node A 410 then sends the newly trained C-GANs to each of the edge nodes as shown at 448. As previously described, the C-GANs matching the known classes of an edge node are sent to that edge node. Thus, the central node A 410 sends to the edge node E₁ 414 the C-GAN

$${G}_{1}^{q}$$

452D for the class C₁ 422, the C-GAN

$${G}_{2}^{q}$$

454D for the class C₂ 424, and the C-GAN

$${G}_{j}^{q}$$

456D for the class Cⱼ 428, and sends to the edge node Eₓ 416 the C-GAN

$${G}_{0}^{q}$$

450D for the class C₀ 432, the C-GAN

$${G}_{2}^{q}$$

454D for the class C₂ 424, and the C-GAN

$${G}_{i}^{q}$$

458D for the class Cᵢ 438. As illustrated, although both the edge node E₁ 414 and the edge node Eₓ 416 include the C-GAN

$${G}_{2}^{q}$$

454D, the training process ensure that these are the now the same model and are well generalized.

At the end of the federation training process, the central node A 410 also sends to each edge node all C-GANs for classes that are not locally known to the edge node so that each edge node has all the C-GANs known to the federation. Thus, as illustrated, the central node A 410 sends to the edge node E₁ 414 the C-GAN

$${G}_{0}^{q}$$

450D for the class C₀ 432 and all the C-GANs for the additional classes up to the C-GAN

$${G}_{i}^{q}$$

458D for the class Cᵢ 438 and sends to the edge node Eₓ 416 the C-GAN

$${G}_{1}^{q}$$

452D for the class C₁ 422 and all the C-GANs for the additional classes up to the C-GAN

$${G}_{j}^{q}$$

456D for the class Cⱼ 428. As note previously, C-GANs are trained to generate points that are close to a given conditional sample point from a given class. As will be explained in more detail to follow, this characteristic will be exploited for training meta-classifiers at the central node.

### C.2 Generative Synthetic Samples

The next step is for the central node A 410 to obtain a set Xᵢ of samples for each class Cᵢ. As a result of the federated process described previously, the central node A 410 has all available C-GANs. The use of the C-GANs is avoided at the central node A 410, however, since the C-GANs are conditioned on real samples, which should not be transferred from the edge nodes in order to maintain privacy. Instead, the following is relied upon:
1. Real samples from each class, if available at the central node (if the central node is also used for the processes in similar fashion to other nodes, it may obtain real documents for one or more classes); and/or
2. Generative synthetic samples obtained from the edge nodes. Generative synthetic samples are synthetic, but are general, representative of the real samples, and thus are not ‘catastrophically noisy’—seeing as they are created in the edge nodes with the C-GANs.

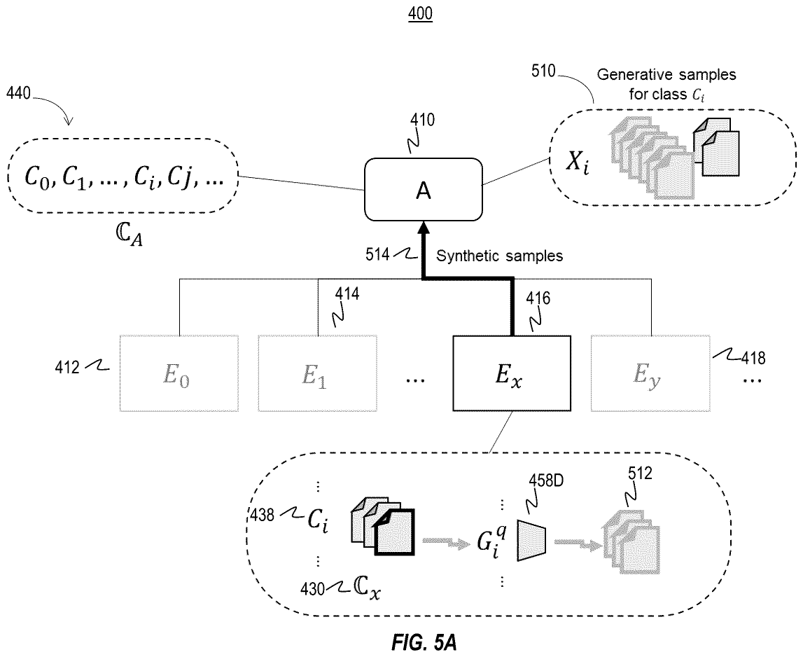

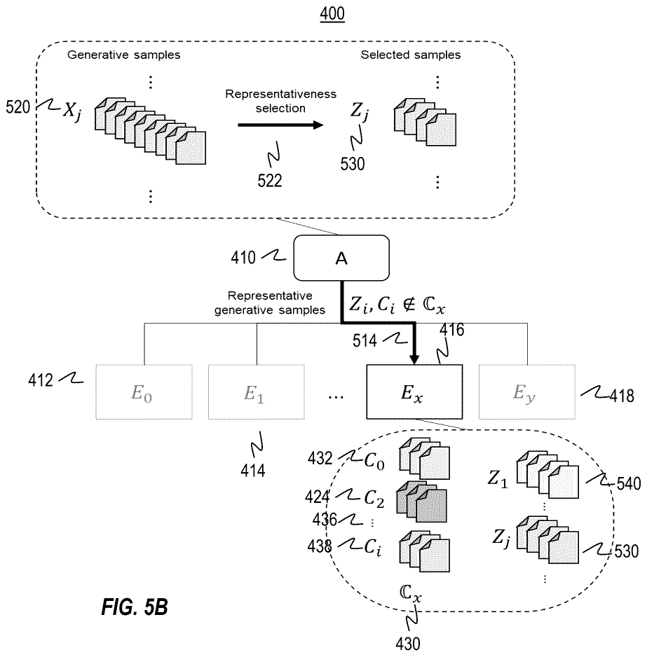

FIG. 5A illustrates generative synthetic samples Xᵢ for each class Cᵢ being collected at the central node A 410. As illustrated, the edge node Eₓ 416 uses the C-GAN

$${G}_{i}^{q}$$

458D to generate a set of generative synthetic document samples 512 from the real document samples that are part of the class Cᵢ 438. Although not illustrated, the edge node Eₓ 416 can also generate a set of generative synthetic samples using the C-GAN

$${G}_{0}^{q}$$

### 450D and the C-GAN

$${G}_{2}^{q}$$

454D. It will be noted, however, that the edge node Eₓ 416 will only generate generative synthetic samples for classes that are locally known to it. Thus, the edge node Eₓ 416 will not use the C-GAN

$${G}_{1}^{q}$$

### 452D or the C-GAN

$${G}_{j}^{q}$$

456D to generate a set of generative synthetic samples. The process described in relation to the edge node Eₓ 416 can be applied to the other edge nodes.

As shown at 514, the set of generative synthetic document samples 512 is provided to the central node A 410. The central node A 410 combines the set of generative synthetic samples 512 with any generative synthetic samples for the class Cᵢ from other edge nodes and/or real samples already at the central node into the set of generative synthetic samples Xᵢ 510. As discussed, the set of generative synthetic samples Xᵢ 510 is created based on real samples for that class at the edge nodes. The central node A 410, or an attacker that is able to obtain the generative synthetic samples, is not able to reverse engineer the real samples. Hence, a high-enough quality of data is obtained at the central node A 410 for training meta-classifiers as will be explained in more detail to follow, without sacrificing the privacy constraints of FL.

As previously described, the edge node Eₓ 416 does not know the class Cⱼ 428 and thus has no real samples to use to generate any generative synthetic samples. However, the embodiments disclosed herein will need the edge node Eₓ 416 to have some generative synthetic samples for the class Cⱼ to use in training a meta-classifier. Accordingly, the embodiments disclosed herein provide a way for suppling the edge node Eₓ 416 with generative synthetic samples for classes it does not know.

For example, FIG. 5B shows a set of generative synthetic document samples Xⱼ 520 that has been created by the central node A 410 for the class C₁ 428 from generative synthetic document samples provided by various edge nodes and/or by real document samples already at the central node. As shown at 522, the central node A 410 selects a subset of representative document samples of the set of generative synthetic document samples Xⱼ 520 to include in a set of generative synthetic document samples Zⱼ 530 for the locally unknown class Cⱼ 428. As discussed, the objective is ultimately to allow the edge node Eₓ 416, which does not know class Cⱼ 428 to generate representative synthetic document samples of that class, which will subsequently be used as input to a meta-classifier of that class. Therefore, the selection process 522 should ideally prioritize diverse and representative document samples of the class Cⱼ 428. A purely random sampling could suffice, but in other embodiments a method based on selecting the document samples farthest from the centroid of a clustering approach could be applied. Thus, any reasonable fitting method can be used for the selection process 522.

As shown at 514, the set of generative synthetic document samples Zⱼ 530 is provided to the edge node Eₓ 416. In addition, using a similar process, a set of generative synthetic document samples Z₁ 540 for the unknown class C₁ 422 is selected and provided to the edge node Eₓ 416 by the central node A 410. Thus, the edge node Eₓ 416 includes both real document samples for its known classes and generative synthetic document samples from the its unknown classes so that it has document samples for all the federation known classes. This process is also performed on all of the other edge nodes so that they also have real document samples and generative synthetic document samples for all the federation known classes.

### C.3 Federated Meta-Classifier Training

The embodiments disclosed herein obtain one meta-classifier per document class. The embodiments leverage a ranker such as the ranker 340 or 350 that provide a similarity-scoring function to compare document samples. In the embodiments, the ranker may comprise a cosine similarity scoring over an encoding of the document samples. The ranker may be further specialized for comparing cross-classes document samples. For ease of explanation and illustration, the following discussion may abstract the ranker and refers simply to the computation of similarity scores.

The training of each meta-classifier Mᵢ requires positive and negative examples for the document class. This is straightforwardly orchestrated in the embodiments disclosed herein as there is a set of labeled document samples Xᵢ for each class Cᵢ as previously described. In the embodiments disclosed herein, each input to the meta-classifier is a pair (a, b) wherein:
a is a sample xᵢ of a class Cᵢ and
b is a sequence of similar document samples to a—from the same class (‘positive’ example) or different (‘negative’ example) class.

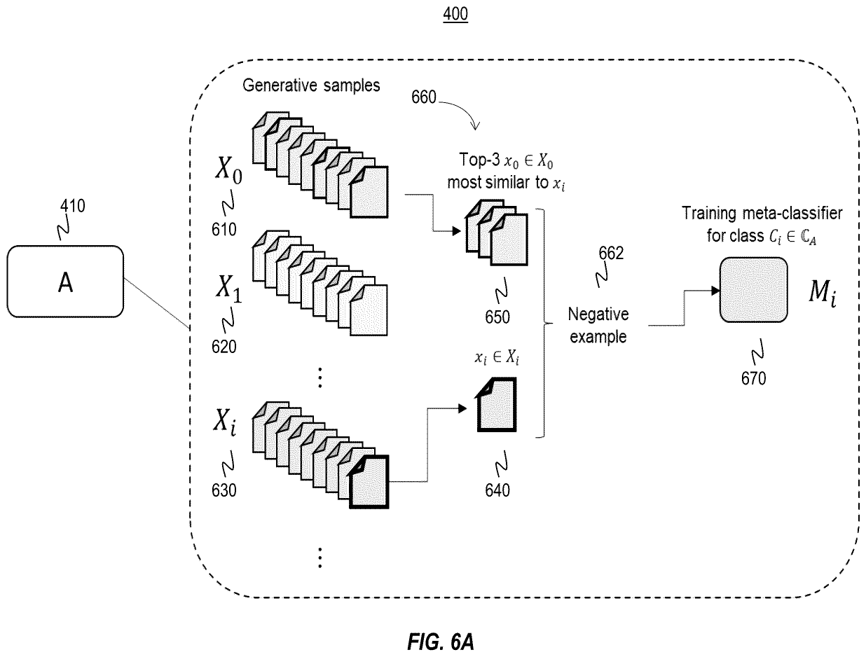

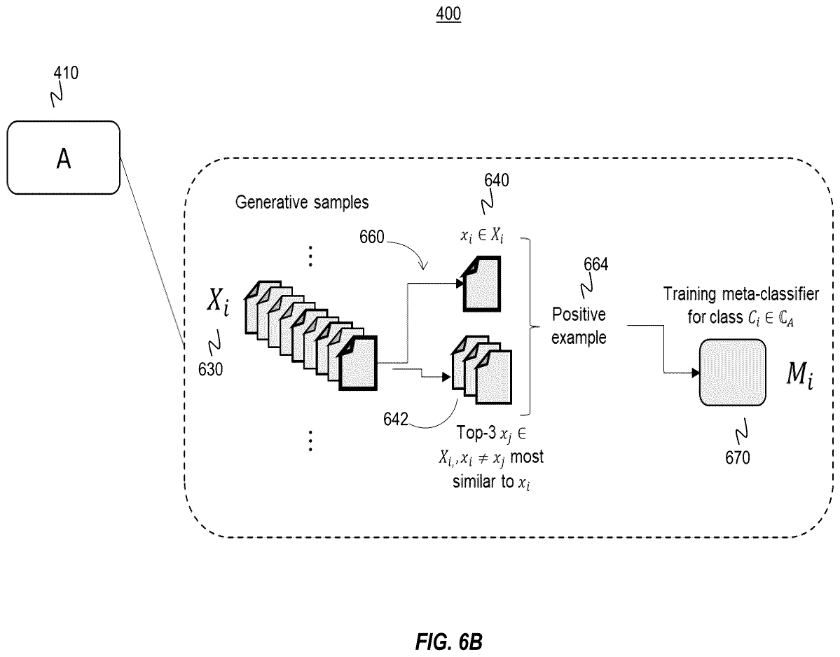

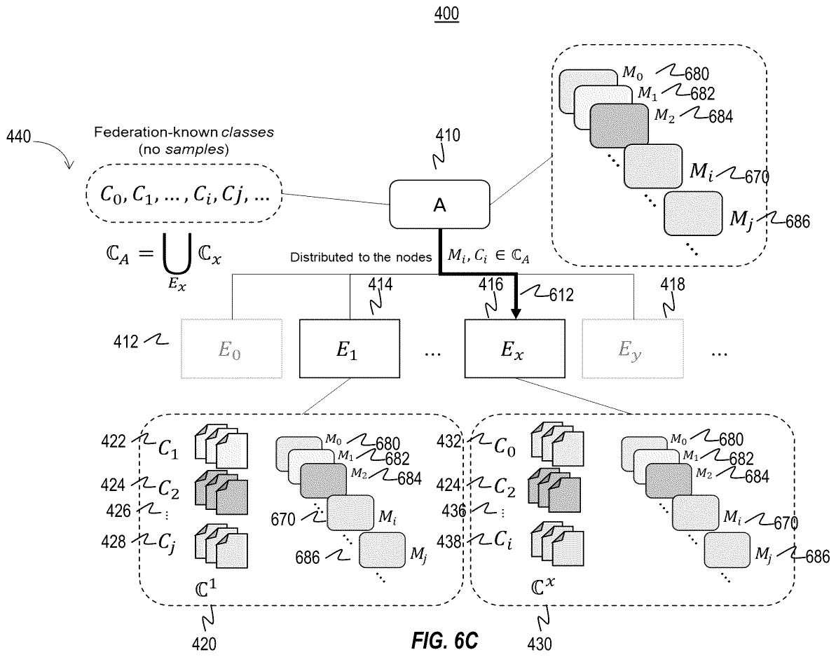

FIG. 6A illustrates a negative example that is used to train a meta-classifier. As illustrated, the central node A 410 has generated a set of generative synthetic document samples X₀ 610 for the class C₀ 432, a set of generative synthetic document samples X₁ 620 for the class C₁ 422, and a set of generative synthetic document samples Xᵢ 630 for the class Cᵢ 438. When training a meta-classifier Mᵢ 670 for the class Cᵢ 438 a negative example (example from a class different than the class Cᵢ 438) is needed. Accordingly, a sample 640 of the set of generative synthetic document samples Xᵢ 630 is selected. In addition, the three document samples 650 of the set of generative synthetic document samples X₀ 610 that are determined by a ranker 660 to be the most similar to sample 640 are also selected. The sample 640 and the three document samples 650 are then paired (i.e., the pair (a, b)) to become a negative example 662 that is input into the meta-classifier Mᵢ 670 to train the meta-classifier Mᵢ 670. This process is also performed to select the three most similar document samples of the generative synthetic document samples X₁ 620 to pair with the sample 640 to become the negative example 662 and further performed on all the other sets of generative synthetic document samples.

FIG. 6B illustrates a positive example that is used to train a meta-classifier. As illustrated, the ranker 660 determines the three document samples 642 of the set of generative synthetic document samples Xᵢ 630 that are the most similar to the sample 640. The sample 640 and the three document samples 642 are then paired (i.e., the pair (a, b)) to become a positive example 664 that is input into the meta-classifier Mᵢ 670 to train the meta-classifier Mᵢ 670.

The process of training a meta-classifier using a negative and positive example is then performed for each document class. As shown in FIG. 6C, this results in a trained meta-classifier for each document class. As illustrated, there is a trained meta-classifier M₀ 680 for the class C₀ 432, a trained meta-classifier M₁ 682 for the class C₁ 422, a trained meta-classifier M₂ 684 for the class C₁₂ 424, the trained meta-classifier Mᵢ 670 for the class Cᵢ 438, and a trained meta-classifier Mⱼ 686 for the class Cⱼ 428. Although not illustrated, the ellipses in FIG. 6C illustrate that there can be any number of additional trained meta-classifiers for any number of additional federation-known classes.

As shown at 612, the trained meta-classifiers for all the federation known document classes [symbol] _{A} 440 are sent to each of the edge nodes. For example, FIG. 6C shows that the trained meta-classifier M₀ 680 for the class C₀ 432, the trained meta-classifier M₁ 682 for the class C₁ 422, the trained meta-classifier M₂ 684 for the class C₂ 424, the trained meta-classifier Mᵢ 670 for the class Cᵢ 438, and the trained meta-classifier Mⱼ 686 for the class Cⱼ 428 have been sent to the edge nodes E₁ 416 and Eₓ 416. Although not illustrated, the trained meta-classifiers are sent to the other edge nodes.

### C.4 Online Document Classification

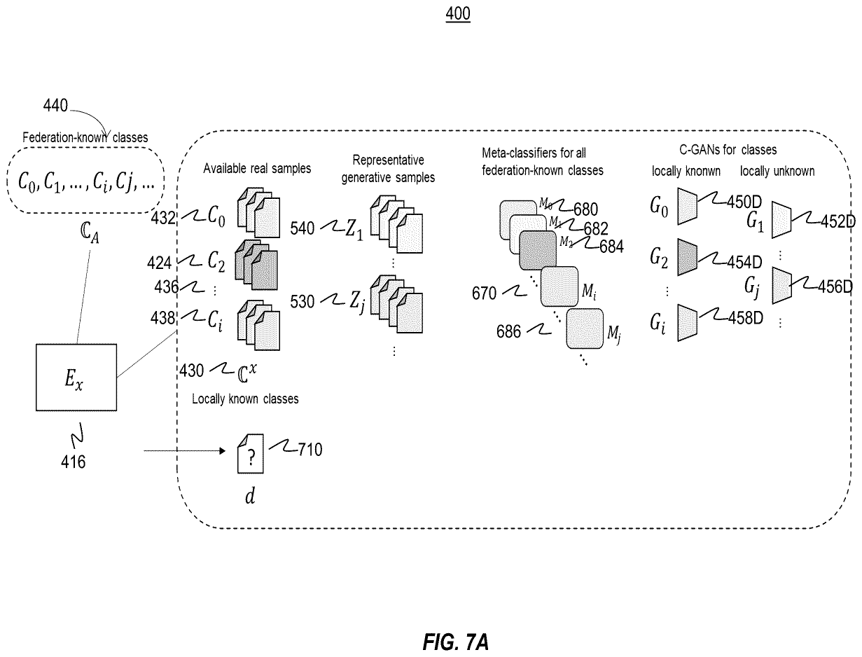

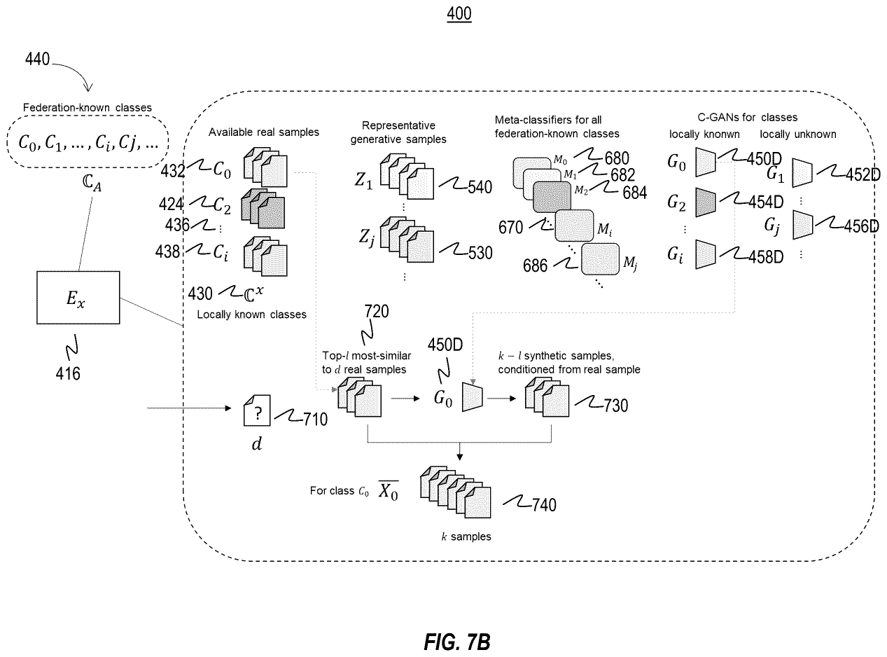

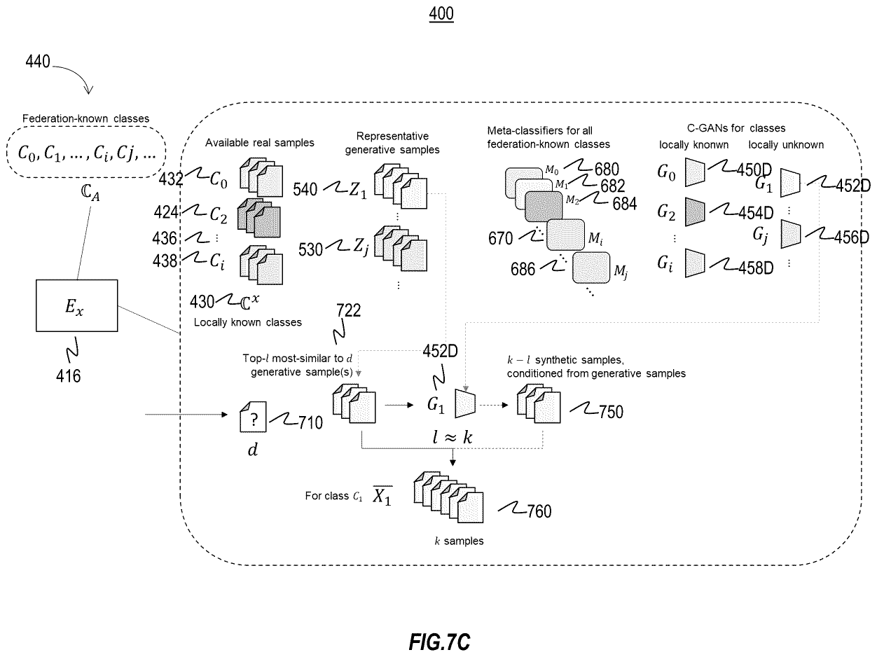

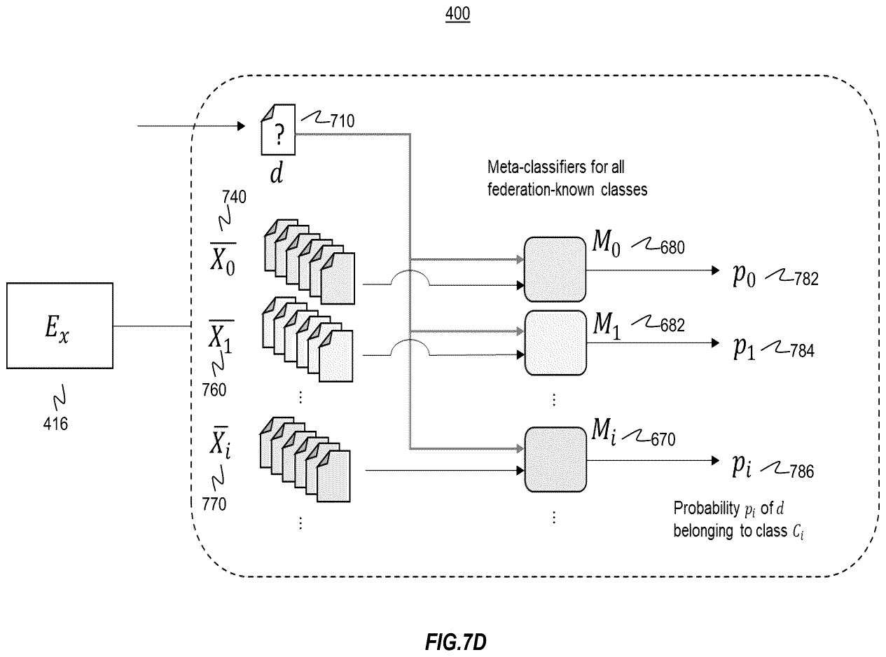

FIG. 7A illustrates an embodiment of the edge environment 400 at a time after the model training described in relation to FIGS. 4A-6C has been completed. In particular, FIG. 7A shows the state of the edge node Eₓ 416. It will be appreciated that the discussion of the edge node Eₓ 416 applies to the other edge nodes of the edge environment 400.

As illustrated, the edge node Eₓ 416 includes available real document samples for the locally known document classes including the class C₀ 432, the class C₂ 424, and the additional classes 436 up to the class C₁ 428. In addition, the edge node Eₓ 416 includes representative generative synthetic document samples Z₁ 540 for the locally unknown class C₁ 422, Zⱼ 530 for the locally unknown class C₁ 428, and any number of additional generative synthetic document samples for any further locally unknown classes as illustrated in the figure by the ellipses.

As illustrated, the edge node Eₓ 416 further includes the trained meta-classifiers for all federation-known classes including the trained meta-classifier M₀ 680 for the class C₀ 432, the trained meta-classifier M₁ 682 for the class C₁ 422, the trained meta-classifier M₂ 684 for the class C₂ 424, the trained meta-classifier Mᵢ 670 for the class Cᵢ 438, and the trained meta-classifier Mⱼ 686 for the class Cⱼ 428. Further, the edge node Eₓ 416 includes C-GANs for the locally known classes including C-GAN G₀ 450D for the class C₀ 432, the C-GAN G₂ 454D for the class C₂ 424, and the C-GAN Gᵢ 458D for the class Cᵢ 428 and the C-GANs for the locally unknown classes including C-GAN G₁ 452D for the class C₁ 422, and a C-GAN Gⱼ 454D for the class Cⱼ 428. It will be appreciated that in FIGS. 7A-7C, the superscript for each C-GAN has been omitted since these refer to the round of federation training and thus are not relevant to the document classification process shown in these figures.

FIGS. 7A-7D show that a document d 710 of an undetermined document class is received at the edge node Eₓ 416. At such time, a document classification process is performed at the edge node Eₓ 416, which consists of exercising the meta-classifiers, in parallel, for each new sample, to determine the document class of the document d 710 or if the document d 710 is of a federation-unknown class.

To perform the document classification process, for each federation-known class Cᵢ∈ [symbol] _{A}, k document samples X̅ᵢ are obtained for invoking the corresponding meta-classifier Mᵢ. This is done for the both the locally known and locally unknown classes at the edge node Eₓ 416.

FIG. 7B illustrates the processes for the locally known classes. If Cᵢ is a locally known class, Cᵢ∈ [symbol] ₓ, k real document samples are obtained from that class. These should be the top-k real document samples most similar to document d 710 according to the same similarity ranking as in the meta-classifier training previously described. For example, for the class C₀ 432, the top-k real document samples 720 are obtained, in some embodiments by the ranker 660 (not illustrated in FIG. 7B). The top-k real document samples 720 then become part of a set of document samples X̅₀ 740.

In some embodiments, a smaller number l<k of real document samples are directly obtained from the real document samples of the class C₀ 432. The remaining k−l document samples 730 are generated from the C-GAN G₀ 450D, which is conditioned on one or more of the top-k real document samples 720. The smaller number l<k of real document samples and the generated document samples 730 become part of the set of document samples X̅₀ 740.

FIG. 7C illustrates the processes for the locally unknown classes. For locally unknown classes Cᵢ∉ [symbol] ₓ a similar process to that of FIG. 7B is performed, but it is preferred that the number of document samples l be closer, if not equal, to k—that is, to use the most-similar generative synthetic document samples directly since the most-similar generative synthetic document samples were generated by a C-GAN based on real document samples. For example, the top-k generative synthetic document samples 722 are obtained, in some embodiments by the ranker 660 (not illustrated in FIG. 7C) from generative synthetic document samples Z₁ 540 for the unknown class C₁ 422. generative synthetic document samples 722 then become part of a set of document samples X̅₁ 760.

In some embodiments, generative synthetic document samples Z₁ 540 for the unknown class C₁ 422 does not include enough document samples. Accordingly, in such embodiments additional generative synthetic document samples 750 are generated from the C-GAN G₁ 452D, which is conditioned on one or more of the generative synthetic document samples 722. The generative synthetic document samples 722 and the additional generative synthetic document samples 750 become part of the set of document samples X̅₁ 760.

With the sets of document samples X̅₀, X̅₁, . . . , X̅ᵢ, . . . for each class Cᵢ∈ [symbol] _{A}, the process proceeds to invoke the meta-classifiers, in parallel as shown in FIG. 7D. As illustrated in FIG. 7D, the edge node Eₓ 416 includes the set of document samples X̅₀ 740, the set of document samples X̅₁ 760, a set of document samples X̅ᵢ 770, and any number of additional sets of document samples as illustrated by the ellipses in the figure. The edge node Eₓ 416 also includes meta-classifiers for all the federation-known classes, including the trained meta-classifier M₀ 680 for the class C₀ 432, the trained meta-classifier M₁ 682 for the class C₁ 422, the trained meta-classifier Mᵢ 670 for the class Cᵢ 438, as well as meta-classifiers for all the other federation-known classes as illustrated by the ellipses in the figure.

When the edge node Eₓ 416 receives the document d 710, the meta-classifiers receive the document d 710 and the relevant set of document samples as input. For example, as illustrated, the meta-classifier M₀ 680 receives the document d 710 and the document samples X̅₀ 740 as input, the meta-classifier M₁ 682 receives the document d 710 and the set of document samples X̅₁ 760 as input, and the meta-classifier Mᵢ 670 receives the document d 710 and the set of document samples X̅ᵢ 770 as input.

The meta-classifiers then generate a probability score that specifies how likely it is that the document d 710 is included in the document class of the set of document samples input into the meta-classifier. For example, as illustrated the meta-classifier M₀ 680 generates a probability score p₀ 782, the meta-classifier M₁ 682 generates a probability score p₁ 784, and the meta-classifier Mᵢ 670 generates a probability score pᵢ 786.

From these probability scores 782, 784, and 786, a decision heuristic is applied to determine the likely class of document d 710. For example, in one embodiment the probability score 782, 784, and 786 having the highest value is determined to be the likely document class of the document d 710. This is accordingly flagged and indexed appropriately. If an edge node gets a low probability score for all classes, then this is flagged as a likely federation-unknown class and indexed appropriately. For example, suppose that the probability score 782 has a value of 0.7, the probability score 784 has a value of 0.8, and the probability score 786 has a value of 0.6. In such case, the document d 710 would be flagged as being part of class C₁ 422 and this would be indexed appropriately.

In one embodiment, a predetermined threshold of 0.5 is applied for determining relevance of a probability score. Thus, if all probability scores pᵢ are below 0.5, it is determined that the document d 710 belongs to a federation-unknown class. In alternative embodiments, the threshold value may vary, or different decision heuristics can be made.

On the other hand, if one or more probability scores pᵢ are above the 0.5 threshold, thus showing relevance, the document class Cᵢ assigned to document d 710 is the one corresponding to the highest probability score. For example, suppose that the probability score 782 has a value of 0.4, the probability score 784 has a value of 0.8, and the probability score 786 has a value of 0.6. In such case, the class C₀ 432 would be deemed irrelevant and would no longer be considered. However, since the other probability scores are above 0.5, their documents classes would be considered relevant and the document d 710 would be flagged as being part of class C₁ 422 since the probability score 784 is higher than the probability score 786 and this would be indexed appropriately. Once the document d 710 has been classified at the edge node Eₓ 416 in the manner previously described the edge node Eₓ 416 is able to route the document d 710 to the appropriate processing pipeline for information extraction and other desired actions. With this online document classification process an edge node who might not have access to a given document class at training time nonetheless can classify a novel sample as belonging to that class. This would be an example of a federation-known, but edge node-unknown class.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

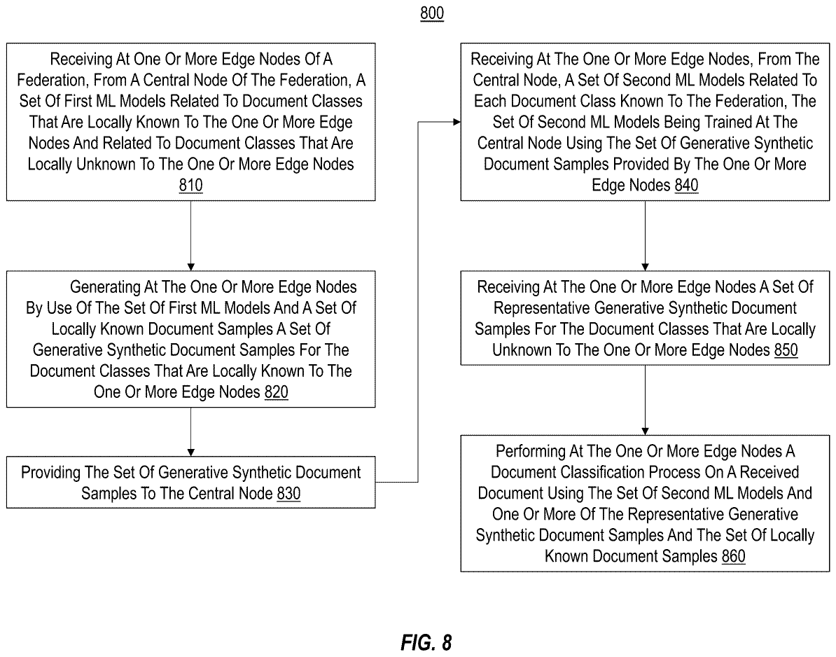

Directing attention now to FIG. 8, an example method 800 according to some embodiments is disclosed. The method 800 will be discussed with reference to one or more of the figures previously described, although the method 800 is not limited to any particular embodiment.

The method 800 includes receiving at one or more edge nodes of a federation, from a central node of the federation, a set of first ML models related to document classes that are locally known to the one or more edge nodes and related to document classes that are locally unknown to the one or more edge nodes (810). For example, as previously described, the edge nodes E₀ 412, E₁ 414, . . . , Eₓ 416, E_{y} 418 receive the C-GANs for each of their respective locally known document classes and locally unknown document classes from the central node A 410 after a predetermined number of federation training rounds. During each federation training round, the edge nodes use document samples from their known document classes to train the C-GANs and then send them back to the central node A 410 as shown in FIGS. 4A-4E.

The method 800 includes generating at the one or more edge nodes by use of the set of first ML models and a set of locally known document samples a set of generative synthetic document samples for the document classes that are locally known to the one or more edge nodes (820). For example, as previously described in relation to FIG. 5A, the edge nodes E₀ 412, E₁ 414, . . . , Eₓ 416, E_{y} 418 generate the generative synthetic document samples using the trained C-GANs for the locally known document classes and the set of locally known document samples.

The method 800 includes providing the set of generative synthetic document samples to the central node (830). For example, as previously described the edge nodes E₀ 412, E₁ 414, . . . , Eₓ 416, E_{y} 418 provide the set of generative synthetic document samples to central node A 410.

The method 800 includes receiving at the one or more edge nodes, from the central node, a set of second ML models related to each document class known to the federation, the set of second ML models being trained at the central node using the set of generative synthetic document samples provided by the one or more edge nodes (840). For example, as previously discussed in relation to FIGS. 6A-6C the edge nodes E₀ 412, E₁ 414, . . . , Eₓ 416, E_{y} 418 receive the meta-classifiers for all federation known document classes from the central node A 410.

The method 800 includes receiving at the one or more edge nodes a set of representative generative synthetic document samples for the document classes that are locally unknown to the one or more edge nodes (850). For example, as previously discussed in relation to FIG. 5B the edge nodes E₀ 412, E₁ 414, . . . , Eₓ 416, E_{y} 418 receive the generative synthetic document samples for the document classes that are locally unknown from the central node A 410.

The method 800 includes performing at the one or more edge nodes a document classification process on a received document using the set of second ML models and one or more of the representative generative synthetic document samples and the set of locally known document samples (860). For example, as previously discussed in relation to FIGS. 7A-7D the edge nodes E₀ 412, E₁ 414, . . . , Eₓ 416, E_{y} 418 perform the document classification process when the document d 710 is received.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

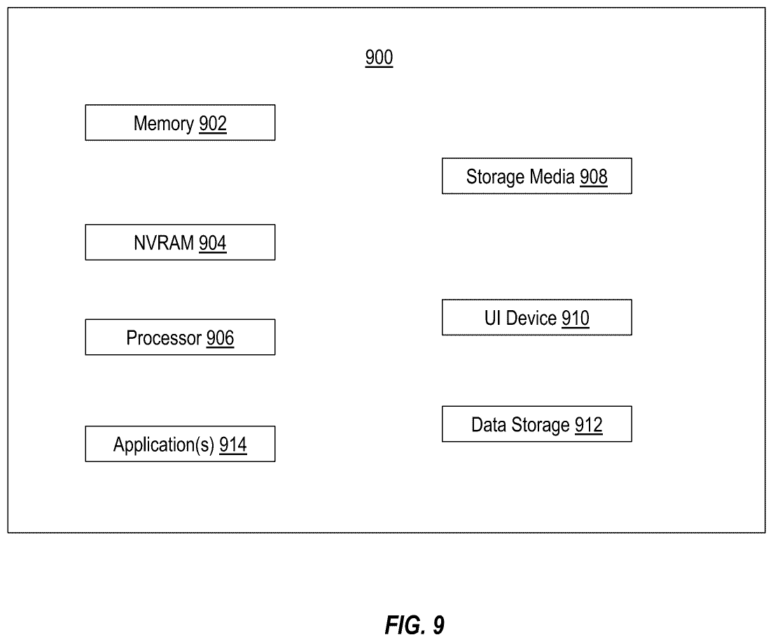

With reference briefly now to FIG. 9, any one or more of the entities disclosed, or implied, by any figure discussed herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving at one or more edge nodes of a federation, from a central node of the federation, a set of first ML models related to document classes that are locally known to the one or more edge nodes and related to document classes that are locally unknown to the one or more edge nodes;
generating at the one or more edge nodes by use of the set of first ML models and a set of locally known document samples a set of generative synthetic document samples for the document classes that are locally known to the one or more edge nodes;
providing the set of generative synthetic document samples to the central node;
receiving at the one or more edge nodes, from the central node, a set of second ML models related to each document class known to the federation, the set of second ML models being trained at the central node using the set of generative synthetic document samples provided by the one or more edge nodes;
receiving at the one or more edge nodes a set of representative generative synthetic document samples for the document classes that are locally unknown to the one or more edge nodes; and
performing at the one or more edge nodes a document classification process on a received document using the set of second ML models and one or more of the representative generative synthetic document samples and the set of locally known document samples.

2. The method of claim 1, further comprising:
providing the trained first set of first ML models to the central node without providing the set of locally known document samples, wherein those of the first set of ML models related to the document classes that are locally known to the one or more edge nodes are trained using the set of locally known document samples.

3. The method of claim 2, wherein those of the first set of ML models related to the document classes that are locally known to the one or more edge nodes are trained using the set of locally known document samples during a predetermined number of federation training rounds.

4. The method of claim 1, where performing the document classification process on the received document comprises:
inputting the received document into each one of the second set of ML models;
inputting a document sample set including a subset of the known set of locally known document samples for document classes locally known to the one or more edge nodes or including a subset of the set of generative synthetic document samples for the document classes that are locally unknown to the one or more edge nodes into each one of the second set of ML models;
generating by each one of the second set of ML models a probability score for each document class that is related to each one of the second set of ML models based on the input received document and document sample set; and
classifying the received document as belonging to the document class having a highest probability score or as belonging to a federation unknown document class.

5. The method of claim 4, wherein the document sample set for the document classes locally known to the one or more edge nodes also includes a subset of generative synthetic document samples and the document sample set for the document classes locally unknown to the one or more edge nodes also includes a further subset of generative synthetic document samples generated using the subset of the set of generative synthetic document samples.

6. The method of claim 4, further comprising:
receiving a predetermined threshold value;
determining if each of the probability scores is above the predetermined threshold value;
classifying the received document as belonging to the document class having the highest probability score that is above the predetermined threshold; or
classifying the received document as belonging to the federation unknown document class when all the probability scores are below the predetermined threshold value.

7. The method of claim 4, wherein the subset of the known set of locally known document samples or the subset of the set of generative synthetic document samples included in the document sample set include document samples determined to be similar to the received document.

8. The method of claim 1, wherein the generative synthetic document samples are provided to the central node without providing the set of locally known document samples used to generate the generative synthetic document samples.

9. The method of claim 1, wherein the first ML model is a conditioned generative adversarial network (C-GAN).

10. The method of claim 1, wherein the second ML model is a meta-classifier.

11. A non-transitory storage medium having stored therein instructions that are executable by one or more hardware processors to perform operations comprising:
receiving at one or more edge nodes of a federation, from a central node of the federation, a set of first ML models related to document classes that are locally known to the one or more edge nodes and related to document classes that are locally unknown to the one or more edge nodes;
generating at the one or more edge nodes by use of the set of first ML models and a set of locally known document samples a set of generative synthetic document samples for the document classes that are locally known to the one or more edge nodes;
providing the set of generative synthetic document samples to the central node;
receiving at the one or more edge nodes, from the central node, a set of second ML models related to each document class known to the federation, the set of second ML models being trained at the central node using the set of generative synthetic document samples provided by the one or more edge nodes;
receiving at the one or more edge nodes a set of representative generative synthetic document samples for the document classes that are locally unknown to the one or more edge nodes; and
performing at the one or more edge nodes a document classification process on a received document using the set of second ML models and one or more of the representative generative synthetic document samples and the set of locally known document samples.

12. The non-transitory storage medium of claim 11, further comprising:
providing the trained first set of first ML models to the central node without providing the set of locally known document samples, wherein those of the first set of ML models related to the document classes that are locally known to the one or more edge nodes are trained using the set of locally known document samples.

13. The non-transitory storage medium of claim 12, wherein those of the first set of ML models related to the document classes that are locally known to the one or more edge nodes are trained using the set of locally known document samples during a predetermined number of federation training rounds.

14. The non-transitory storage medium of claim 11, where performing the document classification process on the received document comprises:
inputting the received document into each one of the second set of ML models;
inputting a document sample set including a subset of the known set of locally known document samples for document classes locally known to the one or more edge nodes or including a subset of the set of generative synthetic document samples for the document classes that are locally unknown to the one or more edge nodes into each one of the second set of ML models;
generating by each one of the second set of ML models a probability score for each document class that is related to each one of the second set of ML models based on the input received document and document sample set; and
classifying the received document as belonging to the document class having a highest probability score or as belonging to a federation unknown document class.

15. The non-transitory storage medium of claim 14, wherein the document sample set for the document classes locally known to the one or more edge nodes also includes a subset of generative synthetic document samples and the document sample set for the document classes locally unknown to the one or more edge nodes also includes a further subset of generative synthetic document samples generated using the subset of the set of generative synthetic document samples.

16. The non-transitory storage medium of claim 14, further comprising:
receiving a predetermined threshold value;
determining if each of the probability scores is above the predetermined threshold value;
classifying the received document as belonging to the document class having the highest probability score that is above the predetermined threshold; or
classifying the received document as belonging to the federation unknown document class when all the probability scores are below the predetermined threshold value.

17. The non-transitory storage medium of claim 14, wherein the subset of the known set of locally known document samples or the subset of the set of generative synthetic document samples included in the document sample set include document samples determined to be similar to the received document.

18. The non-transitory storage medium of claim 11, wherein the generative synthetic document samples are provided to the central node without providing the set of locally known document samples used to generate the generative synthetic document samples.

19. The non-transitory storage medium of claim 11, wherein the first ML model is a conditioned generative adversarial network (C-GAN).

20. The non-transitory storage medium of claim 11, wherein the second ML model is a meta-classifier.
